(19) United States
(12) Patent Application Publication
(10) Pub. No.: US 2026/0065346 A1
(43) Pub. Date: Mar. 5, 2026

(54) Natural Language Processing for Extracting Specific Items from a List of Ingredients

(71) Applicant: Maplebear Inc., San Francisco, CA (US)

(72) Inventors: Riddhima Sejpal, Dublin, CA (US); Jatin Jain, Issaquah, WA (US); Naval Shah, Toronto (CA)

(21) Appl. No.: 18/820,082

(22) Filed: Aug. 29, 2024

(51) Int. Cl. G06Q 30/0601; G06F 16/245

(52) U.S. Cl. CPC G06Q 30/0631; G06Q 30/0603; G06Q 30/0619; G06Q 30/0627; G06Q 30/0635; G06F 16/245

(57) ABSTRACT

An online system receives a list of ingredients and corresponding quantities of each ingredient. Based on an item catalog of specific items offered by a source, the online system retrieves items offered by the source matching the ingredients and selects an item for an ingredient. Because the source may not offer an item in the same quantity specified by the list of items, the online system also maps a quantity of an ingredient in the list to a quantity of the selected item in a unit in which the source offers the corresponding item. The online system may convert a quantity of an ingredient to a quantity of an item through application of one or more rules or through application of one or more trained models to the quantity of the ingredient.

### BACKGROUND

Various online systems offer items for acquisition by users, with an online system receiving an order including one or more items from a user and providing the items included in the order to the user. For example, selecting one or more items for inclusion in an order via one or more interfaces generated and presented by the online system. Subsequently, the user receives the selected items from the online system. For example, the online system allocates the order including the items to a picker who obtains the items included in the order from a source (e.g., a retailer) and delivers the obtained items to a location included in the order.

To simplify creation of orders, an online system may receive a list from a user, from a third party system, or from an application. The list includes identifiers of items and corresponding quantities of each item. For example, the list is a recipe maintained by a third party system, with the recipe including individual items and quantities for different individual items. A third party system may communicate a list to the online system in response to an instruction from a user, allowing the user to leverage information maintained by a third party system to create an order.

Because many third party systems or applications generating or maintaining lists do not fulfill orders for items, the lists generated or maintained by them often include generic item descriptors that generically describe an ingredient (e.g., “milk”) rather than a specific references to items that can be purchased (e.g., “1 gallon Brand X 2% milk). A generic item descriptor may be an item category or other information identifying one or more attributes common to one or more specific items. For example, a list of items includes a generic item descriptor of “milk,” rather than include a specific milk item offered by a source (e.g., a specific brand of milk). These lists of generic item descriptors are usually in the form of unstructured text, which does not align with any database of actual items that can be acquired to fulfill the list.

Additionally, a source offers various specific items in specific quantities, which often differ from a quantity associated with a generic item descriptor in a list. For example, a source offers a specific brand of chicken stock in 32-oz packages, while a list specifies 48 ounces of a generic item descriptor of “chicken stock.” Variations between quantities of generic descriptions of items in a list and quantities of specific items offered by a source, conventional online systems are unable to automatically create an order from a list including generic item descriptors and associated quantities. Instead, conventional online systems rely on receiving selections of specific items and quantities of the specific items corresponding to generic item descriptors in the list from interactions by the user.

Moreover, the quantities associated with the generic item descriptors are also typically in the form of unstructured text. In contrast, the selections of specific items and quantities are specified as structured data, such as specific identifiers for the items and specific number of units of the items to be ordered. In practice, it is not trivial to map the unstructured generic item descriptors and associated quantities to structured data that specifically identifies an item and a number of units of that item that is sufficient to fulfill the generic item descriptors and associated quantities.

### SUMMARY

In accordance with one or more aspects of the disclosure, an online system creates an order for a user to be fulfilled from a source. The order includes one or more items and identifies the source from which the items are to be obtained. Additionally, the order includes a location for delivering the obtained items and may include a time interval for delivering the obtained items to the location.

To simplify order creation, rather than identify specific items for inclusion in the order, a request to create an order received by the online system includes a list of one or more generic item descriptors and a quantity associated with each generic item descriptor. For example, the list is a recipe including multiple generic item descriptors and quantities associated with each generic item descriptor.

The list may be maintained by the online system and selected by the user for inclusion in a request to create an order. As another example, the online system receives the list from a third party system, such as in response to the third party system receiving a request from the user to transmit the list to the online system; this allows a user to leverage a list of generic item descriptors maintained by a third party system that does not fulfill orders when creating an order via the online system. In an additional example, the user generates the list through interaction with the online system identifying one or more generic item descriptors and associated quantities.

While including the list having generic item descriptors and associated quantities in a request to create an order allows the user to create an order without identifying specific items, specific items are obtained from a source to fulfill the order. As a source may offer multiple items associated with a generic item descriptor, including the generic item descriptor in an order provides insufficient information for obtaining items to fulfill the order from a source. To further simplify creation of the order based on the list, the online system retrieves an item catalog for a source for fulfilling the order. For example, the source is identified in the request to create the order that includes the list. As another example, the user identifies the source to the online system before providing the online system with the request to create an order that includes the list.

The item catalog for the source includes identifiers of each item offered by the source and attributes associated with each item offered by the source. Attributes of an item include an item size of the item offered by the source, a unit of measurement for the item size, an item type for the item offered by the source, and a unit type for the item offered by the source. The item size and unit of measurement for the item size specify a quantity and corresponding unit of measurement for a discrete unit of the item. The item type indicates whether the item size of the item is consistent across units of the item or varies across units of the item. For example, the item type has a specific value when each unit of the item has a common item size and has an alternative value when the item size varies between different units.

The unit type of an item indicates a smallest unit by which a picker or a user can obtain the item. For example, the unit type indicates that a smallest unit of the item is an individual item having the specified item size. As another example, the unit type indicates a unit of measurement for a specific physical quantity used to determine a smallest unit of the item.

Based on the item catalog, the online system identifies one or more candidate items associated with the generic item descriptor from the list. As further described above, the online system may select the one or more candidate items based on item categories in the item catalog and the generic item descriptor. For example, the online system identifies an item category from the item catalog having at least a threshold measure of similarity to the generic item descriptor and determines items from the item catalog included in the identified item category as the candidate items.

The online system selects an item of the candidate items to associate with the generic item descriptor based on one or more of: characteristics of the user, characteristics of the source, and attributes of each candidate item For example, online system accounts for characteristics of the user from whom the request to create an order including the list by applying a trained purchase model to characteristics of the user and to attributes of each of candidate item, determining a probability of the user including each of the candidate items in an order. The online system selects a candidate item based on their corresponding probabilities of being included in the order. In some embodiments, the online system accounts for a predicted availability of each candidate item when selecting the item associated with the generic item descriptor.

While mapping the generic item descriptor to the selected item determines a specific item offered by the source satisfying the generic item descriptor, individual units of the item offered by the source often have different quantities than the quantity associated with the generic item descriptor by the list. This prevents the quantity associated with the generic item descriptor from being used in an order to determine a quantity of the selected item, item, to obtain. To resolve discrepancies between the quantity associated with the generic item descriptor and quantities of item offered by the source, the online system determines attributes of the selected item from the item catalog. In various embodiments, the attributes of the selected item include an item size, an item type, and a unit type. The item size specifies a quantity of an individual unit of the selected item and a unit of measurement for the quantity. In some embodiments, the unit of measurement for the item size is separately retrieved from the item catalog. The item type indicates whether the item size of the selected item is consistent across units of the item or varies across units of the item. The unit type indicates a smallest unit by which a picker or a user can obtain the selected item from the source.

Based on the quantity associated with the generic item descriptor, the item size, the item type, and the unit type of the selected item, the online system determines an item quantity of the selected item that satisfies the quantity associated with the generic item descriptor. To satisfy the quantity associated with the generic item descriptor, the item quantity equals or exceeds the quantity associated with the generic item descriptor. The item quantity comprises a number of units of the selected item specified in the type of unit specified by the unit type of the selected item so a quantity of the selected item is not less than the quantity associated with the generic item descriptor. Hence, the item quantity specifies a number of units of the selected item to obtain from the source to obtain a quantity of the selected item that is at least the quantity associated with the generic item descriptor.

In various embodiments, the online system determines the item quantity of the selected item by applying one or more rules to the quantity associated with the generic item descriptor, the item size of the selected item, the item type of the selected item, and the unit type of the selected item. Various rules map the quantity associated with the generic item descriptor to the item quantity comprising a number of units of the selected item based on the unit type of the selected item that results in a quantity of the selected item equaling or exceeding the quantity associated with the generic item descriptor. For example, a rule converts the quantity associated with the generic item descriptor to a unit of measurement for the item size and determines the item quantity by dividing the converted quantity associated with the generic item descriptor by the item size of the selected item so the item quantity comprises a number of individual units of the selected item having the item size resulting in a quantity of the selected item that is not less than the quantity associated with the generic item descriptor. One or more rules specify that the value of the item quantity is the smallest integer that is not smaller than the quotient from dividing the quantity associated with the generic item descriptor in the unit of measurement of the item size by the item size when the unit type of the selected item is an individual unit of the item having the item size. Additional rules may differently convert the quantity associated with the generic item descriptor and the item size of the selected item size into a common unit of measurement and determine the item quantity from the quantity associated with the generic item descriptor and the item size in the common unit of measurement.

Alternatively, the online system determines the item quantity of the selected item by applying a trained generative artificial intelligence (AI) model to a prompt including the quantity associated with the generic item descriptor, the item size, the item type, and the unit type of the selected item. Additional attributes of the selected item from the item catalog may also be included in the prompt to the model in various embodiments. For example, the online system generates a prompt for a large language model (LLM) including an instruction to determine the item quantity for the selected item, the quantity associated with the generic item descriptor, the item size, the item type, and the unit type of the selected item. Based on the content included in the prompt and relationships between portions of text learned during a pre-training process, the LLM determines the item quantity for the selected item in the unit type

The online system creates an order including the selected item and the item quantity determined for the selected item for fulfillment from the source. This leverages the item catalog for the source so the online system selects an item offered by the source and associated with the generic item descriptor and determines an item quantity of the selected item to obtain so the quantity associated with the generic item descriptor is satisfied. Having the online system select a specific item and determine the item quantity for the specific item simplifies order creation for a user by allowing identification of the generic item descriptor and a quantity for the generic item descriptor in the request to create the order rather than have the user manually identify a specific item and an item quantity for the specific item for the request. This reduces an amount of interaction by the user with the online system to create an order. In some embodiments, the online system selects an item associated with each generic item descriptor in the list and determines an item quantity for each selected item associated with a generic item descriptor included in the list. This allows the online system to generate a complete order for fulfillment based on a list of generic item descriptors and corresponding quantities by leveraging attributes of items included in the item catalog for a source fulfilling the order.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for determining an item quantity of an item offered by a source based on a quantity of a generic item descriptor, in accordance with one or more embodiments.

FIG. 4 is a process flow diagram of a method for determining an item quantity of an item offered by a source based on a quantity of a generic item descriptor, in accordance with one or more embodiments.

### DETAILED DESCRIPTION

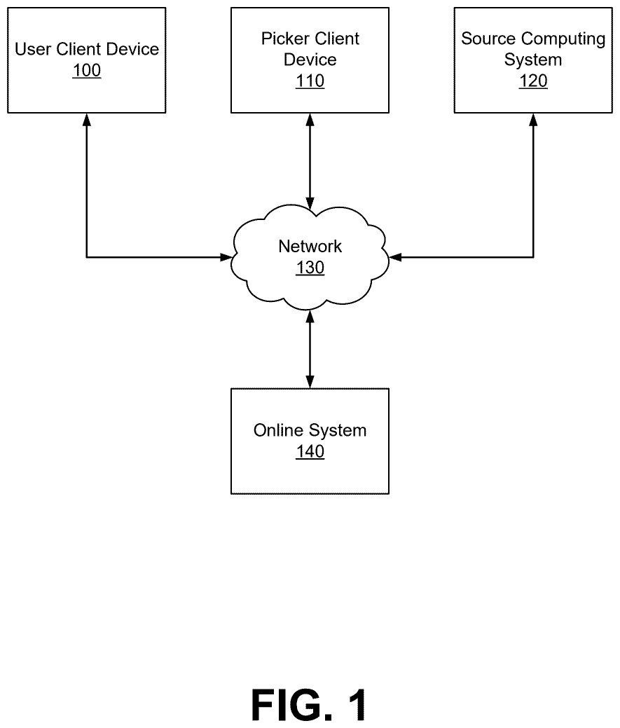

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

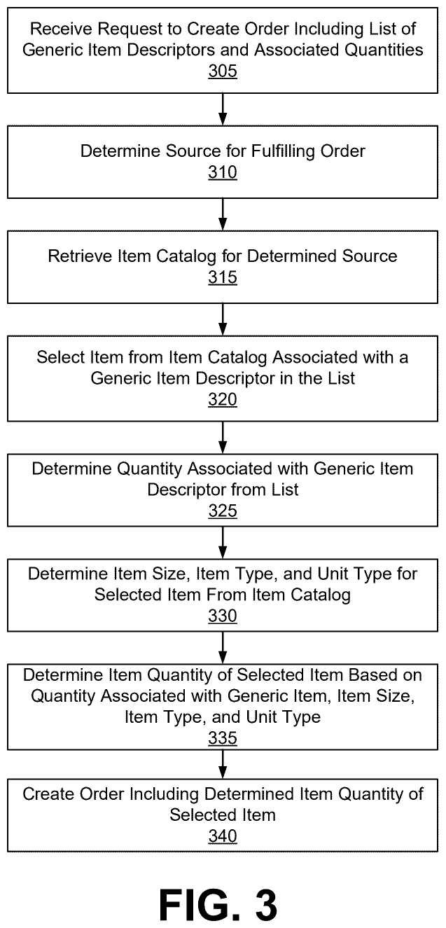

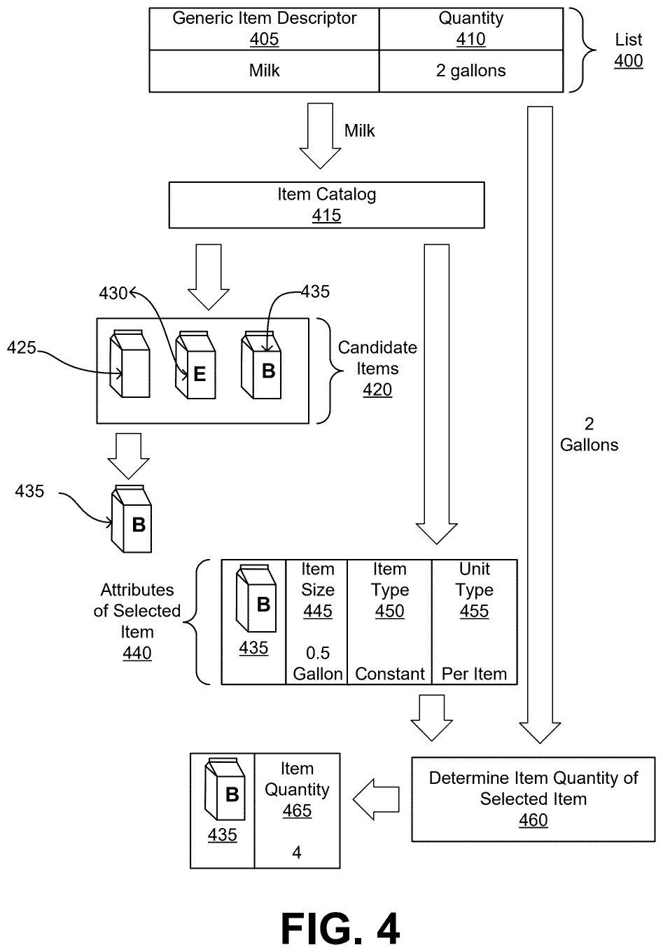

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected. In various embodiments, the ordering interface allows a user to specify one or more generic item descriptors and corresponding quantities in an ordering list or in an order. A generic item descriptor is an item category or other information identifying one or more attributes common to one or more specific items. As further described below in conjunction with FIGS. 3 and 4, the online system 140 may map a generic item descriptor and associated quantity to a specific item and an item quantity of the specific item to facilitate order creation and fulfillment from a particular source.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

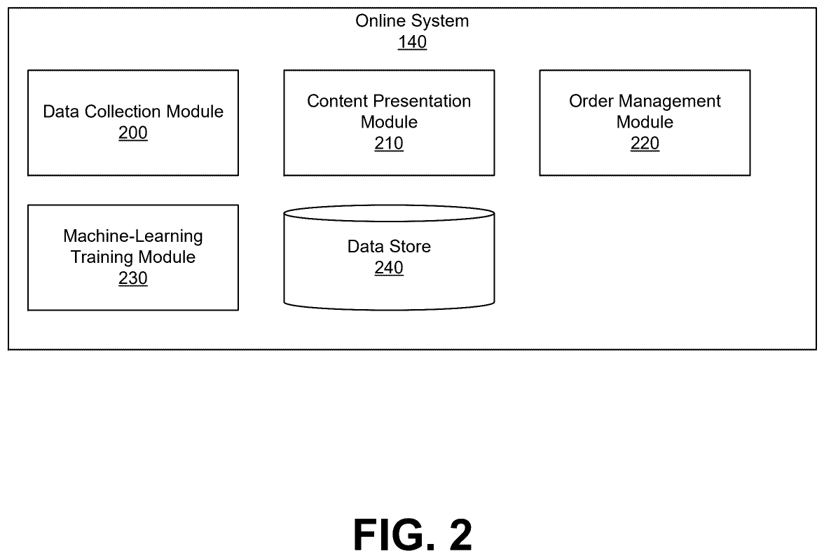

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. In various embodiments, the data collection module 200 obtains or generates an item catalog for a source, with the item catalog for a source including item identifiers of items available from the source, quantities of items available from the source, and one or more attributes associated with each item identifier. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

In various embodiments, the order management module 220 receives one or more generic item descriptors, each associated with a corresponding quantity, in an order. As multiple items offered by a source may be associated with a generic item descriptor and items offered by a source may be available in quantities differing from the quantity associated with the generic item descriptor, the generic item descriptor and associated quantity has insufficient detail for a picker to identify and to obtain a quantity of a specific item from a source. The order management module 220 leverages an item catalog associated with a source to select an item from the source for the generic item descriptor and to determine an item quantity of the selected item to obtain from the source. The item quantity is a number of units of the selected item to obtain from the source so the aggregate quantity of number of units of the selected item equals or exceeds the quantity associated with the generic item descriptor. Based on attributes in the item catalog for the selected item such as an item size of a unit of the selected item, a unit of measurement for the item size, and a unit type of the selected item specifying a smallest unit of the selected item capable of being obtained from the source, as well as the quantity associated with the generic item descriptor, the order management module 220 determines the item quantity of the selected item to obtain from the source, as further described below in conjunction with FIGS. 3 and 4. In various embodiments, the order management module 220 may leverage a generative model or a set of rules to determine an item quantity of a selected item satisfying a quantity of a generic item descriptor.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

For example, the machine-learning training module 230 trains a purchase model to determine a probability of a user including an item in an order based on characteristics of the user and attributes of the item. In various embodiments, the machine-learning training module 230 iteratively trains the purchase model through application to a set of training examples. The machine-learning training module 230 updates parameters of the purchase model based on each of the set of training examples. Each training example includes attributes of an item and characteristics of a user, with a label applied to each training example indicating whether the user included the item in an order. The training examples may be processed together, individually, or in batches. To train the purchase model based on a training example, the machine-learning training module 230 applies the purchase model to the data in the training example to generate an output (e.g., a probability of the user including the item in the training example in an order) based on a current set of parameters of the purchase model. The machine-learning training module 230 scores the output from the purchase model using a loss function. A loss function is a function that generates a score for the output of the purchase model such that the score is higher when the purchase model performs poorly and lower when the purchase model performs well. In various embodiments, the loss function is based on a difference between the output of the purchasing model and a label applied to a training example. Example loss functions include the mean square error function, the mean absolute error, the hinge loss function, and the cross entropy loss function. The machine-learning training module 230 updates the set of parameters for the purchase model based on the score generated by the loss function. For example, the machine-learning training module 230 may apply gradient descent to update the set of parameters comprising the purchasing model.

Further, the machine-learning training module 230 may obtain one or more genitive models in various embodiments. A generative model is a large language model (LLM), such as a generative pre-trained transformer model (GPT) in various embodiments. The generative model generates text in response to a text prompt in various embodiments. Alternatively or additionally, the generative model selects or generates an image in response to a text prompt. A generative model is a model that has been pre-trained on a text corpus including text to output text in response to a text prompt from a user. As another example, a generative model is a generative image model pre-rained on a corpus of images to output an image in response to a received text prompt. Obtaining a pre-trained generative model allows the machine-learning training module 230 to leverage relationships between different text (or images) the generative model learned through application to a text corpus or image corpus including a larger amount of data and more varied data than the maintained by the online system 140. In various embodiments, a generative model configured to receive text as input and to generate text output learns relationships between different portions of text (e.g., words, phrases) during a pre-training process where the generative model is applied to a large text corpus; subsequently, the generative model generates output text by leveraging the previously learned relationships between portions of text during pre-training and the received prompt.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a flowchart of a method for determining an item quantity of an item offered by a source based on a quantity of a generic item descriptor, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

An online system 140 allows a user to create one or more orders that each include one or more items accessible to the online system 140. Subsequently, the online system 140 obtains items included in an order from a source for a user who created the order and provides the items to a location specified by the order. For example, the online system 140 allocates an order from a user to a picker, who obtains the items included in the order from a source included in the order and delivers the items to a location identified by the order. In other embodiments, the online system 140 differently obtains and delivers items included in an order to a user who created the order.

To simplify order creation, the online system 140 may receive a list from a user, from a third party system, or from an application. The list includes one or more generic item descriptors and a quantity corresponding to each generic item descriptor. A generic item descriptor is an item category in some embodiments, while in other embodiments a generic item descriptor comprises other information identifying one or more attributes of one or more items. For example, a third party system maintains various lists, and a user selects a list from the third party system. In response to receiving the selection of the list, the third party system transmits the selected list to the online system 140 in conjunction with an identifier of the user. In various embodiments, a list comprises a recipe including multiple generic item descriptors and quantities associated with each generic item descriptor. Selecting a list allows a user to specify one or more generic item descriptors rather than specifying specific items when creating an order, which reduces an amount of interaction by the user with the online system 140 to create an order.

Various items offered by a source may be associated with a generic item descriptor, and specific items offered by a source are obtained to fulfill an order. As different items offered by a source may correspond to a generic item descriptor, generic item descriptor in the list provide insufficient detail for the online system 140 to create an order capable of being fulfilled. Additionally, a source of items offers items in specific quantities, and a quantity in which a source offers an item may differ from a quantity corresponding to a generic item descriptor associated with the item. For example, a list includes a generic item descriptor of “broth” with an associated quantity of 40 ounces, while a source offers items associated with the generic item descriptor of “broth” in 12 ounce or 20 ounce quantities. Such difference between the quantity associated with the generic item descriptor and quantities offered for items associated with the generic item descriptor prevents the quantity associated with the generic item descriptor from being used to create an order.

To simplify creation of an order for a user based on a list (or based on one or more generic item descriptors), the online system 140 receives 305 a request to create an order including a list having generic item descriptors and a quantity associated with each generic item descriptor. A quantity associated with a generic item descriptor also includes a unit of measurement for the quantity. For an example, the list includes a generic item descriptor of “chicken thighs” that is associated with a quantity of “1.5” and a unit of measurement for the quantity of “lb.” to indicate 1.5 pounds of an item associated with the generic item descriptor of “chicken thighs” are included in the list of items.

In various embodiments, the online system 140 receives 305 the request including the list from a third party system in response to the third party system receiving a selection of the list from the user. When the online system 140 receives 305 a request to create an order including the list from a third party system, the request includes an identifier of the user from the third party system along with the list. As another example, the online system 140 receives 305 the list from the user through one or more interactions by the user with the online system 140, with one or more of the interactions including the identifier of the user.

Additionally, the online system 140 determines 310 a source for fulfilling the order. In some embodiments, the request including the list includes an identifier of a source for fulfilling the order. In other embodiments, the online system 140 receives 305 the request for creating the order including the list and subsequently receives a selection of a source for fulfilling the order from the user. Alternatively, the online system 140 receives a selection of the source for fulfilling the order from the user then receives 305 the request to create the order including the list.

The online system 140 retrieves 315 an item catalog associated with the source for fulfilling the order. For example, the online system 140 retrieves 315 an item catalog stored in the data store 240 and associated with the source for fulfilling the order. As another example, the online system 140 retrieves 315 the item catalog from a source computing system 120 of the source for fulfilling the order. The item catalog associated with the source includes identifiers of each item offered by the source and attributes of each item offered by the source.

Attributes of an item included in the item catalog include an item size, a unit of measurement for the item size, an item type, and a unit type for the item. The item size and the unit of measurement for the item size specify a quantity for a discrete unit of the item and a corresponding unit of measurement for a discrete unit of the item. In some embodiments, the item size includes both a quantity and the unit of measurement for the quantity. For example, an item size of 20 and a unit of measurement of “ounces” indicates a single unit of the item includes 20 ounces. The item type indicates whether the item size of the item is consistent or variable across units of the item. For example, the item type has a specific value when each unit of the item has a common item size and has an alternative value when the item size varies between different units of the item. In some embodiments, attributes of the item include an average item size when the item type indicates the item size varies between different units of the item. For example, attributes of a broth item offered in 20 ounce packages by the source include an item size of 20 ounces, a unit of measurement of ounces, and a value for the item type indicating the item size is consistent across units of the item. As another example, attributes of a packaged ground meat item include a value for the item type indicating different units of the item have different item sizes, an average item size of one pound, and a unit of measurement of pounds.

The unit type of an item indicates a smallest unit by which a picker or a user can obtain the item. Different values of the unit type correspond to different categories of units for the item. For example, the unit type has a particular value (e.g., “per item”) to specify that an individual unit of an item is a unit having the item size associated with the item. Other values for the unit type indicate a specific physical quantity of the item used to identify a smallest unit of the item. Example physical quantities indicated by the unit type used to identify a smallest unit of the item measured by weight include ounces or pounds. Similarly, example physical quantities identified by the unit type include ounces, gallons, liters, or pints to indicate the item is measured by a unit of volume. The unit type may specific a unit indication value (e.g., “per item,” “per weight,” “per volume,” etc.) and a unit of measurement in some embodiments, while in other embodiments the unit type comprises the unit indication value and the item catalog separately maintains the unit of measurement for the unit type.

For a generic item descriptor included in the list, the online system 140 selects 320 an item associated with the generic item descriptor based on the item catalog for the source. In various embodiments, the online system 140 determines a set of candidate items for the generic item descriptor from the item catalog for the source. In various embodiments, the item catalog for the source is hierarchically organized, with different levels of the hierarchy providing different levels of details about items. A lower level in the hierarchy is associated with a higher level of the hierarchy, with the lower level in the hierarchy providing an increasing amount of detail about individual items relative to the higher level. For example, a level of the item catalog is a particular item category, and a lower level of the item catalog associated with the level includes specific items within the item category. The online system 140 identifies a level of the item catalog with a description (or a name) having at least a threshold measure of similarity (e.g., cosine similarity, dot product) to the generic item descriptor and determines items associated with the identified level of the item catalog as the set of candidate items. The online system 140 selects 320 one or candidate items as the item associated with the generic item descriptor.

In some embodiments, the online system 140 selects 320 an item associated with the generic item descriptor by applying a trained purchase model to each candidate item of the set identified for the generic item descriptor. The trained purchase model determines a probability of the user including a candidate item in the order based on characteristics of the user and attributes of the candidate item. The trained purchase model may account for times when the user previously included a candidate item in an order (e.g., an amount of time between a time when the request to create the order was received 305 and a time when the online system 140 previously received an order from the user including the candidate item). The trained purchase model may include a decay constant that decreases a weighting of inclusion of the candidate item in orders over time, so prior orders from the user including the candidate item received more recent to the time when the online system 140 received 305 the request to create the order have higher weights than prior orders received less recent to the time when the online system 140 received 305 the request to create the order. The trained purchase model accounts for a frequency with which the user included the candidate item in prior orders in some embodiments. The online system 140 applies the trained purchase model to each combination of the user and a candidate item of the set, ranks the candidate items of the set based on the probabilities, and selects 320 a candidate item of the set having at least a threshold position in the ranking (e.g., a highest position in the ranking) in some embodiments. Alternatively, the online system 140 selects 320 a candidate item of the set having a maximum probability of being included in the order by the user.

As another example, the online system 140 applies the availability model, further described above in conjunction with FIG. 2, to the candidate items and to the determined source. The availability model is a machine-learning model trained to predict an availability of an item at a particular source. In some embodiments, the online system 140 ranks the candidate items based on their corresponding predicted availabilities and selects 320 a candidate item having at least a threshold position in the ranking. Alternatively, the online system 140 selects 320 a candidate item having a maximum predicted availability. In various embodiments, the online system 140 identifies a group of candidate items having at least a threshold predicted availability (or a group of candidate items having at least a threshold position in a ranking based on corresponding predicted availabilities) and ranks the candidate items of the group based on probabilities of the user including each candidate item of the group in the order through application of the purchasing model. The online system 140 selects 320 a candidate item having at least a threshold position in the ranking based on the probabilities or selects 320 a candidate item having a maximum probability in various embodiments.

For the selected item associated with the generic item descriptor in the list of items, the online system 140 determines 325 a quantity associated with the generic item descriptor in the list of items and determines 330 an item size, an item type, and a unit type for the selected item associated with the generic item descriptor. Based on the quantity associated with the generic item descriptor, the item size of the selected item associated with the generic item descriptor, the item type of the selected item associated with the generic item descriptor, and the unit type of the selected item associated with the generic item descriptor, the online system 140 determines 335 an item quantity of the selected item for the generic item descriptor to include in the order. The item quantity comprises a number of units of the selected item specified according to the unit type of the selected item, where the number of units of the selected item results in a quantity of the selected item that equals or exceeds the quantity associated with the generic item descriptor. Determining the item quantity associated with the selected item maps the quantity associated with the generic item descriptor to a number of units of the selected item, as offered by the source, resulting in a quantity of the selected item that at least equals the quantity associated with the generic item descriptor.

In various embodiments, the online system 140 applies one or more rules to the quantity associated with the generic item descriptor, the item size of the selected item, the item type of the selected item, and the unit type of the selected item to determine 335 the item quantity for the selected item associated with the generic item descriptor in the unit type in which the source offers the selected item. The rules map the quantity associated with the generic item descriptor to the item quantity based on the item size, the item type, and the unit type of the selected item associated with the generic item descriptor offered by the source. One or more rules determine 335 the item quantity for the selected item type in a number of units of the selected item specified by the unit type based on the item size of the selected item and the quantity associated with the generic item descriptor in various embodiments. As further described above, the unit type indicates a smallest unit by which a picker or a user can obtain the item from the source, so accounting for the unit type determines 335 the item quantity based on the smallest unit of the selected item offered by the source to simplify obtaining the selected item from the source.

Different rules specify different conditions for mapping the quantity associated with the generic item descriptor to the item quantity of the selected item associated with the generic item descriptor based on the quantity associated with the generic item descriptor, the item size of the selected item associated with the generic item descriptor, the item type of the selected item associated with the generic item descriptor, and the unit type of the selected item associated with the generic item descriptor. In various embodiments, the online system 140 selects one or more rules based on the item type of the selected item, a unit of measurement for the item size of the selected item, or the unit type of the selected item. Application of the selected one or more rules determines 335 the item quantity of the selected item associated with the generic item descriptor in the unit type of the selected item based on criteria in the selected one or more rules that map the quantity associated with the generic item descriptor a count of units of the selected item based on the item size of the selected item, simplifying subsequent retrieval of a quantity of the selected item from the source satisfying the quantity associated with the generic item descriptor.

For example, the selected item has an item type indicating the item size of the selected item is consistent across units of the item, so a selected rule converts the quantity associated with the generic item into a unit of measurement of the item size of the selected item and determines 335 the item quantity of the specific item based on the converted quantity associated with the generic item in the unit of measurement for the item size of the selected item. For example, the online system 140 determines 335 the item quantity of the specific item by dividing the quantity associated with the generic item in the unit of measurement for the item size of the selected item by the item size of the selected item. In an example, the quantity associated with the generic item descriptor is one pound, while the item size of the selected item associated with the generic item descriptor is eight ounces; applying a rule converts the one pound quantity associated with the generic item descriptor into an equivalent quantity of 16 ounces in the unit of measurement of measurement for the item size of the selected item, ounces, and divides the 16 ounces representing the quantity associated with the generic item descriptor in the unit of measurement of the item size by the eight ounce item size to determine 335 an item quantity of two units of the selected item to include in the order.

As another example, the selected item has an item type indicating each unit of the selected item has a variable item size, so the online system 140 applies a rule that determines a representative item size for the selected item based on item sizes of previously obtained units of the selected item. The representative item size may be retrieved from the item catalog, which stores a representative item size in association with the selected item. In some embodiments, the online system 140 determines the representative item size based on units of the item obtained from the source during a specific time interval (e.g., within a threshold amount of time from a time when the online system 140 received 305 the request to create the order). For example, a representative item size of the selected item comprises an average item size of multiple units of the selected item previously obtained from the source during the specific time interval. As another example, the representative item size of the selected item comprises a median item size of multiple units of the selected item previously obtained from the source during the specific time interval. The online system 140 divides the quantity associated with the generic item descriptor converted into the unit of measurement of the representative item size of the selected item to determine 335 the item quantity of the specific item based on the quantity associated with the generic item in the unit of measurement for the representative item size of the selected item. Determining the representative item size allows the online system 140 to account for variations in individual item sizes for a selected item having a variable item size for different units of the selected item when determining 335 the item quantity of the selected item associated with the generic item descriptor.

Similarly, in response to the quantity associated with the generic item descriptor specifying a count of individual items associated with the generic item descriptor and the unit type of the selected item indicating unit of measurement of a quantity of the selected item (e.g., a weight of the selected item) determines how much of the item is obtained from the source, the online system 140 applies one or more rules that convert the count of the individual items associated with the generic item descriptor to a corresponding unit of measurement of the quantity of the selected item associated with the generic item descriptor. For example, the online system 140 retrieves a representative per item weight of the selected item from the item catalog. In various embodiments, the representative per item weight is a ratio of a weight of the selected item obtained from the source during a specific time interval to a count of the selected item obtained from the source during the specific time interval. In other embodiments, the online system 140 determines the representative per item weight based on one or more alternative statistics determined from a weight of the selected item obtained from the source during a specific time interval and a count of the selected item obtained from the source. Similarly, the online system 140 determines a representative per item quantity for the selected item based on an aggregated amount of the selected item in the unit of measurement from the unit type obtained from the source during a specific time interval and a count of the selected item obtained during the specific time interval. For example, the representative per item quantity is a ratio of the aggregated amount of the selected item in the unit of measurement from the unit type obtained from the source during a specific time interval to the count of the selected item obtained during the specific time interval. The online system 140 determines 335 the item quantity of the selected item as a product of the quantity associated with the generic item descriptor in the unit of measurement for the unit type and the representative per item quantity for the selected item associated with the generic item descriptor. This determines 335 the item quantity of the selected item in a unit of measurement for the unit type when the quantity associated with the generic item descriptor is a per item count and the unit type associated with the selected item by the source is per unit of measurement for a quantity.

In various embodiments, determining the number of units of the selected item based on the quantity associated with the generic item descriptor and the item size of the selected item results in a fractional number of units of the selected item. As sources are unlikely to offer fractional numbers of units of an item, the online system 140 applies one or more rules to convert a fractional number of units for the selected item based on the quantity associated with the generic item descriptor and the item size of the selected item to an integer. In various embodiments, in response to determining a fractional value for the item quantity of the selected item based on the quantity associated with the generic item descriptor and the item size of the selected item, a rule determines 335 the item quantity of the selected item by rounding the fractional value for the quantity of the selected item up to a smallest integer that is not smaller than the fractional value. Such a rule determines 335 the item quantity of the selected item as an integer number of units of the selected item, so a product of the item size of the selected item and the integer number of units of the selected item is not less than the quantity associated with the generic item descriptor.

In some embodiments, the list included in the request to create the order associates multiple quantities with the generic item descriptor, with different quantities having different units of measurement. For example, the generic item descriptor associates a quantity with the generic item descriptor specifying a number of individual items associated with the generic item descriptor and associates an additional quantity with the generic item descriptor having a different unit of measurement (e.g., ounces, pounds, etc.). To determine 335 the item quantity of the selected item associated with the generic item descriptor, the online system 140 determines the unit type associated with the selected item by the source from the item catalog and selects a quantity associated with the generic item descriptor having the determined unit type. For example, in response to the unit type associated with the selected item in the item catalog identifying “per item,” the online system 140 determines 335 the quantity of the selected item as the quantity associated with the generic item descriptor specifying a number of individual items. Similarly, in response to the unit type associated with the selected item associated with the generic item descriptor having a unit type indicating another unit of measurement for a quantity (e.g., pound, ounce, etc.), the online system 140 determines 335 the item quantity of the selected item associated with the generic item descriptor as the quantity associated with the generic item descriptor having the unit of measurement of the unit type associated with the selected item by the source.

One or more rules may account for additional attributes of the selected item obtained from the item catalog when determining 335 the item quantity of the selected item that satisfies the quantity associated with the generic item descriptor. For example, one or more attributes of an item describe how an individual unit of the item is packaged. As an example, an attribute of an item identifies a density of the item included in an individual unit, providing information about a quantity of an item may be obtained from an individual unit of the item. In various embodiments, one or more rules determine 335 the item quantity for the selected item based on the item size of the selected item, the quantity associated with the generic item descriptor, and information describing a density of the selected item included in an individual unit. For example, in response to the density of the selected item included in an individual unit being less than a threshold value, the online system 140 determines 335 the item quantity by increasing a value determined from the quantity associated with the generic item descriptor and the item size of the selected item by a specific factor or by a specific amount to account for a unit of the selected item being less densely packed with the selected item. As another example, in response to the density of the selected item included in an individual unit being greater than a threshold value, the online system 140 determines 335 the item quantity by decreasing a value determined from the quantity associated with the generic item descriptor and the item size of the selected item by a specific factor or by a specific amount to account for a unit of the selected item being more densely packed with the selected item.

Alternatively, the online system 140 determines 335 the item quantity of the selected item by applying a trained model, such as a trained generative model, to the quantity associated with the generic item descriptor and to the item size, the item type, and the unit type associated with the selected item associated with the generic item descriptor. Additional attributes of the selected item from the item catalog may also be included in the input to the model in various embodiments. For example, the online system 140 generates a prompt for a large language model (LLM) including an instruction to determine 335 the item quantity for the selected item, including the quantity associated with the generic item descriptor, and including attributes of the item from the item catalog retrieved 315 for the source (e.g., an item size, an item type, a unit type, etc.). Based on the content included in the prompt and relationships between portions of text learned during a pre-training process, the LLM determines 335 the item quantity for the selected item in the unit type based on the quantity associated with the generic item descriptor, the item size of the selected item associated with the generic item descriptor, and the item type associated with the generic item descriptor.

The online system 140 creates 340 the order including the item quantity of the selected item associated with the generic item descriptor. In various embodiments, the online system 140 selects 320 an item from the item catalog associated with each generic item descriptor of the list and determines 335 an item quantity of each selected item associated with a generic item descriptor of the list based on a corresponding quantity of each generic item descriptor, as further described above. Selecting 320 an item associated with a generic item category from the source's item catalog and determining 335 an item quantity of the selected item in a unit type of the specific item in the source's item catalog simplifies order creation by allowing a request to create the order to include a generic item descriptor and associated quantity that the online system 140 automatically maps to a specific item offered by the source and an item quantity of the specific item represents in a unit with which the source offers the specific item. Such mapping reduces interaction with the online system 140 by a user by creating 340 the order without the user manually selecting a specific item from a source for a generic item descriptor and manually determining a quantity of the specific item satisfying a quantity associated with the generic item descriptor.

FIG. 4 is a process flow diagram of a method for determining an item quantity of an item offered by a source based on a quantity of a generic item descriptor. An online system 140 creates an order for a user to be fulfilled from a source. The order includes one or more items and identifies the source from which the items are to be obtained. Additionally, the order includes a location for delivering the obtained items and may include a time interval for delivering the obtained items to the location.

To simplify order creation, rather than identify specific items for inclusion in the order, a request to create an order received by the online system 140 includes a list 400 of one or more generic item descriptors 405 and a quantity 410 associated with each generic item descriptor. For example, the list 400 is a recipe including multiple generic item descriptors 405 and quantities 410 associated with each generic item descriptor 405. For purposes of illustration, FIG. 4 shows a list 400 including a single generic item descriptor 405 of “milk” associated with a quantity 410 of “two gallons.”

The list 400 may be maintained by the online system 140 and selected by the user for inclusion in a request to create an order. As another example, the online system 140 receives the list 400 from a third party system, such as in response to the third party system receiving a request from the user to transmit the list 400 to the online system 140. In an additional example, the user generates the list 400 through interaction with the online system 140 identifying one or more generic item descriptors and associated quantities.

While including the list 400 having generic item descriptors 405 and associated quantities 410 in a request to create an order allows the user to create an order without identifying specific items, specific items are obtained from a source to fulfill the order. As a source may offer multiple items associated with a generic item descriptor 405, including the generic item descriptor 405 in an order provides insufficient information for obtaining items to fulfill the order from a source. To further simplify creation of the order based on the list 400, the online system 140 retrieves an item catalog 415 for a source for fulfilling the order. For example, the source is identified in the request to create the order that includes the list 400. As another example, the user identifies the source to the online system 140 before providing the online system 140 with the request to create an order that includes the list 400.

The item catalog 415 for the source includes identifiers of each item offered by the source and attributes associated with each item offered by the source. Attributes of an item include an item size of the item offered by the source, a unit of measurement for the item size, an item type for the item offered by the source, and a unit type for the item offered by the source. As further described above in conjunction with FIG. 3, the item size and unit of measurement for the item size specify a quantity and corresponding unit of measurement for a discrete unit of the item. The item type indicates whether the item size of the item is consistent across units of the item or varies across units of the item. For example, the item type has a specific value when each unit of the item has a common item size and has an alternative value when the item size varies between different units.

The unit type of an item indicates a smallest unit by which a picker or a user can obtain the item. For example, the unit type indicates that a smallest unit of the item is an individual item having the specified item size. As another example, the unit type indicates a unit of measurement for a specific physical quantity used to determine a smallest unit of the item, as further described above in conjunction with FIG. 3.

Based on the item catalog 415, the online system 140 identifies one or more candidate items 420 associated with the generic item descriptor 405 from the list 400. As further described above, the online system 140 may select the one or more candidate items 420 based on item categories in the item catalog 415 and the generic item descriptor 405. For example, the online system 140 identifies an item category from the item catalog 415 having at least a threshold measure of similarity to the generic item descriptor 405 and determines items from the item catalog 415 included in the identified item category as the candidate items 420. In the example of FIG. 4, the online system 140 determines item 425, item 430, and item 435 are candidate items 420 for the generic item descriptor 405 in the list 400.

As further described above in conjunction with FIG. 3, the online system 140 selects an item of the candidate items 420 to associate with the generic item descriptor 405. In various embodiments, the online system 140 accounts for characteristics of the user from whom the request to create an order including the list 400 was received. For example, the online system 140 applies a trained purchase model to characteristics of the user and to attributes of each of item 425, item 430, and item 435, to determine a probability of the user including each of item 425, item 430, and item 435 in an order. The online system 140 selects one of item 425, item 430, and item 435 based on their corresponding probabilities of being included in the order, as further described above in conjunction with FIG. 3. In some embodiments, the online system 140 accounts for a predicted availability of each candidate item 420 when selecting the item associated with the generic item descriptor 405. In the example of FIG. 4, the online system 140 selects item 435 as associated with the generic item descriptor 405. This maps the generic item descriptor 405 to a specific item, item 435, offered by a source fulfilling the order including the generic item descriptor 405.

While mapping the generic item descriptor 405 to item 435 determines a specific item offered by the source satisfying the generic item descriptor 405, individual units of the item 435 offered by the source often have different quantities than the quantity 410 associated with the generic item descriptor 405 by the list 400. This prevents the quantity 410 associated with the generic item descriptor 405 from being used in an order to determine a quantity of the selected item, item 435, to obtain. To resolve discrepancies between the quantity 410 associated with the generic item descriptor 405 and quantities of item 435 offered by the source, the online system 140 determines attributes 440 of the selected item, item 435, from the item catalog 415. In various embodiments, the attributes 440 of the selected item include an item size 445, an item type 450, and a unit type 455. As further described above in conjunction with FIG. 3, the item size 445 specifies a quantity of an individual unit of the selected item and a unit of measurement for the quantity. In some embodiments, the unit of measurement for the item size 445 is separately retrieved from the item catalog 415. The item type 450 indicates whether the item size of the selected item is consistent across units of the item or varies across units of the item. The unit type 455 indicates a smallest unit by which a picker or a user can obtain the selected item. In the example of FIG. 4, item 435 has an item size 445 of 0.5 gallons, an item type 450 indicating that the item size is consistent across different units of item 435, and a unit type 455 indicating that the smallest unit of the item 435 is an individual item having the item size 445. Hence, in the example of FIG. 4, the quantity 410 associated with the generic item descriptor 405 specifies two gallons, while the source offers item 435 in individual 0.5 gallon items.

Based on the quantity 410 associated with the generic item descriptor 405, the item size 445, the item type 450, and the unit type 455 of the selected item, item 435, the online system 140 determines 460 an item quantity 465 of the selected item that satisfies the quantity 410 associated with the generic item descriptor 405. To satisfy the quantity 410 associated with the generic item descriptor 405, the item quantity 465 equals or exceeds the quantity 410 associated with the generic item descriptor 405. The item quantity 465 comprises a number of units of the selected item specified in the type of unit specified by the unit type 455 of the selected item so a quantity of the selected item is not less than the quantity 410 associated with the generic item descriptor 405. Hence, the item quantity specifies a number of units of the selected item to obtain from the source to obtain a quantity of the selected item that is at least the quantity 410 associated with the generic item descriptor 405.

In various embodiments, the online system 140 determines 460 the item quantity of the selected item, item 435, by applying one or more rules to the quantity 410 associated with the generic item descriptor 405, the item size 445 of item 435, the item type 450 of item 435, and the unit type 455 of item. Various rules map the quantity 410 associated with the generic item descriptor 405 to the item quantity 465 comprising a number of units of the selected item, item 435, based on the unit type of the selected item that results in a quantity of the selected item, item 435, equaling or exceeding the quantity 410 associated with the generic item descriptor 405. For example, a rule converts the quantity 410 associated with the generic item descriptor 405 to a unit of measurement for the item size 445 and determines 460 the item quantity 465 by dividing the converted quantity 410 associated with the generic item descriptor 405 by the item size 445 of the selected item, item 435, so the item quantity 465 comprises a number of individual units of the selected item having the item size 445 resulting in a quantity of the selected item that is not less than the quantity 410 associated with the generic item descriptor 405. One or more rules specify that the value of the item quantity 465 is the smallest integer that is not smaller than the quotient from dividing the quantity 410 associated with the generic item descriptor 405 in the unit of measurement of the item size 445 by the item size 445 when the unit type of the selected item is an individual unit of the item having the item size 445. Additional examples of rules for determining 460 the item quantity 465 of the selected item are further described above in conjunction with FIG. 3.

Alternatively, the online system 140 determines 460 the item quantity of the selected item, item 435, by applying a trained generative model to a prompt including the quantity 410 associated with the generic item descriptor 405, the item size 445, the item type 450, and the unit type 455 of the selected item, item 435. Additional attributes of the selected item from the item catalog 415 may also be included in the prompt to the model in various embodiments. For example, the online system 140 generates a prompt for a large language model (LLM) including an instruction to determine 460 the item quantity for the selected item, the quantity 410 associated with the generic item descriptor 405, the item size 445, the item type 450, and the unit type 455 of the selected item, item 435. Based on the content included in the prompt and relationships between portions of text learned during a pre-training process, the LLM determines 460 the item quantity for the selected item, item 435, in the unit type 455. In the example of FIG. 4, the online system 140 determines 460 an item quantity 465 of four for the selected item, item 435. Based on the item catalog 415, the source offers the selected item, item 435, as individual units each having an item size 445 of 0.5 gallons, so the online system 140 determines 460 that an item quantity of four units of item 435, each having an item size 445 of 0.5 gallons, results in an item quantity 465 of item 435 of two gallons, which equals the quantity 410 associated with the generic item descriptor 405 in the list 400.

The online system 140 creates an order including the selected item, item 435, and the item quantity 465 determined for the selected item for fulfillment from the source. This leverages the item catalog 415 for the source so the online system 140 selects an item offered by the source and associated with the generic item descriptor 405 and determines an item quantity of the selected item to obtain so the quantity 410 associated with the generic item descriptor 405 is satisfied. Having the online system 140 select a specific item and determine the item quantity 465 for the specific item simplifies order creation for a user by allowing identification of the generic item descriptor 405 and a quantity 410 for the generic item descriptor 405 in the request to create the or4der rather than have the user manually identify a specific item and an item quantity for the specific item for the request. This reduces an amount of interaction by the user with the online system 140 to create an order. In some embodiments, the online system 140 selects an item associated with each generic item descriptor 405 in the list 400 and determines 460 an item quantity 465 for each selected item associated with generic item descriptor 405 included in the list 400. This allows the online system 140 to generate a complete order for fulfillment based on a list 400 of generic item descriptors 405 and corresponding quantities 410 by leveraging attributes of items included in the item catalog 415 for a source fulfilling the order.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, at the computer system, a request to create an order, the request comprising unstructured text content that includes a list of one or more ingredients and a quantity associated with each ingredient;
identifying an item database associated with a source for fulfilling the order, the item database storing information for each of a plurality of items offered by the source and attributes associated with each of the plurality of items;
parsing, using a natural language processing algorithm, the unstructured text content in the list to identify an ingredient of the one or more ingredients and the quantity associated therewith;
querying the item database using the identified ingredient to retrieve a set of items from the item database;
selecting an item from a set of items from the item database that matches the identified ingredient;
comparing the identified quantity associated with the identified ingredient to the attributes of the selected item stored in the item database, the attributes including an item size of the item, an item type of the item, and a unit type of the item;
generating a number of units of the selected item to include in the order based on the comparing, wherein the number of units is sufficient to fulfill the quantity associated with the selected ingredient; and
outputting the order in response to the request, the order including structured information that identifies the selected item and a quantity of the selected item.

2. The method of claim 1, wherein generating a number of units of the selected item to include in the order based on the comparing comprises:
in response to the item size of the selected item indicating the item size of the selected item is consistent across units of the item size, converting the quantity associated with the ingredient to a unit of measurement of the item size of the selected item; and
identifying the number of units of the selected item by dividing the quantity associated with the ingredient in the unit of measurement of the item size by the item size of the selected item.

3. The method of claim 2, wherein generating a number of units of the selected item to include in the order based on the comparing comprises:
in response to the unit type indicating a specifying a smallest unit of the selected item is a unit having the item size of the selected item and in response to dividing the quantity associated with the ingredient in the unit of measurement of the item size by the item size of the selected item having a fractional value, identifying the number of units of the selected item as a smallest integer that is not smaller than the fractional value.

4. The method of claim 1, wherein generating a number of units of the selected item to include in the order based on the comparing comprises:
in response to the item size of the selected item indicating the item size of the selected item varies across units of the item size, converting the quantity associated with the ingredient to a unit of measurement of the item size of the selected item;
identifying a representative item size for the selected item; and
identifying the number of units of the selected item by dividing the quantity associated with the ingredient in the unit of measurement of the item size by the representative item size of the selected item.

5. The method of claim 4, wherein identifying the number of units of the selected item by dividing the quantity associated with the ingredient in the unit of measurement of the item size by the representative item size of the selected item comprises:
in response to the unit type indicating a specifying a smallest unit of the selected item is a unit having the item size of the selected item and in response to dividing the quantity associated with the ingredient in the unit of measurement of the item size by the representative item size of the selected item having a fractional value, identifying the number of units of the selected item as a smallest integer that is not smaller than the fractional value.

6. The method of claim 4, wherein identifying the representative item size for the selected item comprises:
identifying an average item size of units of the selected item obtained from the source during a specific time interval.

7. The method of claim 1, wherein generating a number of units of the selected item to include in the order based on the comparing comprises:
in response to the quantity associated with the ingredient specifying a count of individual items and the unit type of the selected item indicating a unit of measurement of a quantity of the selected item, retrieving a representative per number of units for the selected item in the unit of measurement indicated by the unit type; and
identifying the number of units of the selected item as a product of the quantity associated with the ingredient and the representative per unit of measurement of the quantity of the selected item.

8. The method of claim 1, wherein generating a number of units of the selected item to include in the order based on the comparing comprises:
generating a prompt including an instruction to identify the number of units of the selected item based on the unit type of the item, the prompt including the quantity associated with the ingredient, the item size of the selected item from the item database, the item type of the selected item from the item database, and the unit type of the selected item; and
applying a large language model to the prompt, the large language model outputting the number of units of the selected item based on the prompt.

9. The method of claim 1, further comprising:
creating the order including the selected item associated with the generated number of units of the selected item.

10. The method of claim 1, wherein selecting an item from a set of items from the item database that matches the identified ingredient comprises:
identifying a set of candidate items from the item database based on the ingredient; and
selecting a candidate item of the set of candidate items based on one or more of characteristics of a user, attributes of each candidate item, and attributes of the source.

11. A computer program product comprising a non-transitory computer readable storage medium having instructions encoded thereon, that when executed by a processor, cause the processor to perform steps comprising:
receiving, at a computer system, a request to create an order, the request comprising unstructured text content that includes a list of one or more ingredients and a quantity associated with each ingredient;
identifying an item database associated with a source for fulfilling the order, the item database storing information for each of a plurality of items offered by the source and attributes associated with each of the plurality of items;
parsing the unstructured text content in the list to identify an ingredient of the one or more ingredients and the quantity associated therewith;
querying the item database using the identified ingredient to retrieve a set of items from the item database;
selecting an item from a set of items from the item database that matches the identified ingredient;
comparing the identified quantity associated with the identified ingredient to the attributes of the selected item stored in the item database, the attributes including an item size of the item, an item type of the item, and a unit type of the item;
generating a number of units of the selected item to include in the order based on the comparing, wherein the number of units is sufficient to fulfill the quantity associated with the selected ingredient; and
outputting the order in response to the request, the order including structured information that identifies the selected item and a quantity of the selected item.

12. The computer program product of claim 11, wherein generating a number of units of the selected item to include in the order based on the comparing comprises:
in response to the item size of the selected item indicating the item size of the selected item is consistent across units of the item size, converting the quantity associated with the ingredient to a unit of measurement of the item size of the selected item; and
identifying the number of units of the selected item by dividing the quantity associated with the ingredient in the unit of measurement of the item size by the item size of the selected item.

13. The computer program product of claim 12, wherein generating a number of units of the selected item to include in the order based on the comparing comprises:
in response to the unit type indicating a specifying a smallest unit of the selected item is a unit having the item size of the selected item and in response to dividing the quantity associated with the ingredient in the unit of measurement of the item size by the item size of the selected item having a fractional value, identifying the number of units of the selected item as a smallest integer that is not smaller than the fractional value.

14. The computer program product of claim 11, wherein generating a number of units of the selected item to include in the order based on the comparing comprises:
in response to the item size of the selected item indicating the item size of the selected item varies across units of the item size, converting the quantity associated with the ingredient to a unit of measurement of the item size of the selected item;
identifying a representative item size for the selected item; and
identifying the number of units of the selected item by dividing the quantity associated with the ingredient in the unit of measurement of the item size by the representative item size of the selected item.

15. The computer program product of claim 14, wherein identifying the number of units of the selected item by dividing the quantity associated with the ingredient in the unit of measurement of the item size by the representative item size of the selected item comprises:
in response to the unit type indicating a specifying a smallest unit of the selected item is a unit having the item size of the selected item and in response to dividing the quantity associated with the ingredient in the unit of measurement of the item size by the representative item size of the selected item having a fractional value, identifying the number of units of the selected item as a smallest integer that is not smaller than the fractional value.

16. The computer program product of claim 14, wherein identifying the representative item size for the selected item comprises:
identifying an average item size of units of the selected item obtained from the source during a specific time interval.

17. The computer program product of claim 11, wherein generating a number of units of the selected item to include in the order based on the comparing comprises:
in response to the quantity associated with the ingredient specifying a count of individual items and the unit type of the selected item indicating a unit of measurement of a quantity of the selected item, retrieving a representative per number of units for the selected item in the unit of measurement indicated by the unit type; and
identifying the number of units of the selected item as a product of the quantity associated with the ingredient and the representative per unit of measurement of the quantity of the selected item.

18. The computer program product of claim 11 wherein, wherein generating a number of units of the selected item to include in the order based on the comparing comprises:
generating a prompt including an instruction to identify the number of units of the selected item based on the unit type of the item, the prompt including the quantity associated with the ingredient, the item size of the selected item from the item database, the item type of the selected item from the item database, and the unit type of the selected item; and
applying a large language model to the prompt, the large language model outputting the number of units of the selected item based on the prompt.

19. The computer program product of claim 11, wherein the non-transitory computer readable storage medium further has instructions encoded thereon that, when executed by the processor, cause the processor to perform steps comprising:
creating the order including the selected item associated with the generated number of units of the selected item.

20. A system comprising:
a processor; and
a non-transitory computer readable storage medium having instructions encoded thereon that, when executed by the processor, cause the processor to perform steps comprising:
receiving, at the computer system, a request to create an order, the request comprising unstructured text content that includes a list of one or more ingredients and a quantity associated with each ingredient;
identifying an item database associated with a source for fulfilling the order, the item database storing information for each of a plurality of items offered by the source and attributes associated with each of the plurality of items;
parsing the unstructured text content in the list to identify an ingredient of the one or more ingredients and the quantity associated therewith;
querying the item database using the identified ingredient to retrieve a set of items from the item database;
selecting an item from a set of items from the item database that matches the identified ingredient;
comparing the identified quantity associated with the identified ingredient to the attributes of the selected item stored in the item database, the attributes including an item size of the item, an item type of the item, and a unit type of the item;
generating a number of units of the selected item to include in the order based on the comparing, wherein the number of units is sufficient to fulfill the quantity associated with the selected ingredient; and
outputting the order in response to the request, the order including structured information that identifies the selected item and a quantity of the selected item.
